(19) United States
(12) Patent Application Publication
(10) Pub. No.: US 2026/0263911 A1
(43) Pub. Date: Sep. 10, 2026

(54) LOTTERY TICKET SELLING SYSTEM HAVING A LOTTERY TICKET PRINTER POWER SENSOR THAT DETECTS THE PRINTING OF DRAW LOTTERY TICKETS BY A DRAW LOTTERY TICKET PRINTER

(71) Applicant: Brightstar Global Solutions Corporation, Providence, RI (US)

(72) Inventor: Robert Corvese, Warwick, RI (US)

(21) Appl. No.: 19/071,412

(22) Filed: Mar. 5, 2025

(51) Int. Cl. A63F 3/06; G06F 3/12; G06Q 20/32

(52) U.S. Cl. CPC A63F 3/0655; G06F 3/1259; G06Q 20/322

(57) ABSTRACT

A lottery ticket selling system including a wager details display device, a ticket courier server causes a display of a code associated with an ordered draw lottery ticket by the wager details display device, a lottery terminal and associated scanner, a lottery ticket printer, and a lottery ticket printer sensor including an electric power level change detector configured to indicate that the lottery printer printed a first draw lottery ticket associated with the code, and cause the ticket courier server to remove a display of a code associated with that draw lottery ticket by the wager details display device.

### BACKGROUND

The present disclosure relates to a lottery ticket selling system having a lottery ticket printer power sensor that detects the printing of draw lottery tickets by a lottery ticket printer.

For a draw lottery ticket for a draw lottery game, a player may select the player numbers or may have an electronic lottery system randomly select the player numbers (which is often referred to as a quick pick). Draw lottery tickets may be purchased in variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates to a lottery ticket selling system including: a wager details display device; a ticket courier server that, responsive to receiving an order for a draw lottery ticket from an electronic player device with a courier mobile application, causes a display of a code associated with the ordered draw lottery ticket by the wager details display device; a lottery terminal and associated scanner, the lottery terminal configured to communicate with a lottery central system; a draw lottery ticket printer; and a lottery ticket printer sensor comprising an electric power level change detector, a transmitter, a processor, and a memory device. The memory device stores a plurality of instructions, which when executed by the processor cause the processor to: receive a first signal from the electric power level change detector that indicates that the draw lottery printer printed a draw lottery ticket corresponding to the code, and send a second signal, via the transmitter, which indicates that the draw lottery ticket printer printed the draw lottery ticket and that causes the ticket courier server to cause a removal of the display of the code associated with that draw lottery ticket by the wager details display device.

In various other embodiments, the present disclosure relates to a lottery ticket selling system including: a wager details display device; a ticket courier server that, responsive to receiving an order for a draw lottery ticket, causes a display of a code associated with an ordered draw lottery ticket by the wager details display device; a lottery terminal and associated scanner; a draw lottery ticket printer; and a lottery ticket printer sensor comprising an electric power level change detector, a transmitter, a processor, and a memory device. The memory device stores a plurality of instructions, which when executed by the processor cause the processor to: receive a first signal from the electric power level change detector that indicates that the draw lottery printer printed a draw lottery ticket, and send a second signal, via the transmitter, which indicates that the draw lottery ticket printer printed the draw lottery ticket and that causes a removal of the display of the code associated with that draw lottery ticket from the wager details display device.

In various other embodiments, the present disclosure relates to a lottery ticket selling system including: a wager details display device; a ticket courier server that, responsive to receiving a first order for a first draw lottery ticket, causes a display of a first code associated with an ordered first draw lottery ticket by the wager details display device; a lottery terminal and associated scanner, the lottery terminal configured to communicate with a lottery central system; a draw lottery ticket printer; and a lottery ticket printer sensor comprising an electric power level change detector, a transmitter, a processor, and a memory device. The memory device stores a plurality of instructions, which when executed by the processor cause the processor to: receive a first signal from the electric power level change detector that indicates that the draw lottery printer printed a first draw lottery ticket associated with the first code, and send a second signal, via the transmitter, which indicates that the draw lottery ticket printer printed the first draw lottery ticket and that causes a removal of the display of the first code associated with that first draw lottery ticket by the wager details display device.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a diagrammatic view of a known lottery ticket selling system.

FIG. 3 is a diagrammatic perspective view of an example lottery ticket selling system having a lottery ticket printer power sensor that detects the printing of draw lottery tickets by a lottery ticket printer of the system in accordance with one example embodiment of the present disclosure.

FIG. 4 is a perspective view of the lottery ticket printer power sensor that detects the printing of the draw lottery tickets by the lottery ticket printer of the lottery ticket selling system of FIG. 3.

FIG. 5 is a flow diagram showing one example method of operating the lottery ticket selling system of FIG. 3.

### DETAILED DESCRIPTION

In various embodiments, the present disclosure relates to a lottery ticket selling system and method of operating the lottery ticket selling system, wherein the lottery ticket selling system includes a lottery ticket printer power sensor that detects printing of draw lottery tickets by a draw lottery ticket printer of the system. The lottery ticket printer power sensor confirms that each ordered and purchased draw lottery ticket is printed by the draw lottery ticket printer before the system proceeds to the process of generating and printing a next ordered and purchased draw lottery ticket.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for selling various other draw lottery tickets.

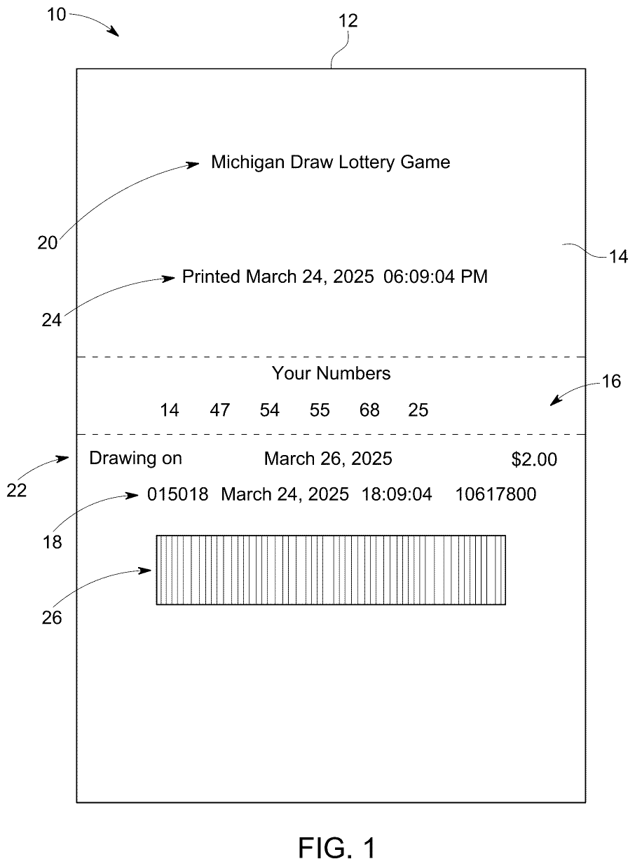

An example physical draw lottery ticket 10 is shown in FIG. 1. This example draw lottery ticket includes: (1) a ticket substrate 12; (2) a front surface 14 of the ticket substrate 12; (3) draw lottery ticket information, including a single set of player numbers (for a single play of draw lottery game), printed on the front surface 14 of the ticket substrate 12; and (4) a back surface (not shown) of the ticket substrate 12. This example draw lottery ticket 10 is for a single play of a draw lottery game (scheduled to take place on Mar. 26, 2025) and includes a single set of player numbers 16 (i.e., player numbers for the single play of the draw lottery game). The draw lottery ticket information in this example includes player numbers 16, a draw lottery ticket identifier 18 that uniquely identifies the draw lottery ticket 10, a game identifier 20 that identifies the draw lottery game, a draw date 22 associated with the draw lottery ticket 10, and a print date 24 on which the draw lottery ticket 10 was printed. The draw lottery ticket information can include text, a draw lottery ticket number such as the draw lottery ticket identifier 18, a draw lottery ticket barcode such as barcode 26, and/or other draw lottery ticket information that is in either or both human readable and machine-readable forms. The draw lottery ticket's barcode 26 is configured to be scanned by a barcode reading device to enable redemption of the draw lottery ticket.

Additionally, for a better understanding of the present disclosure, an example known system and method employed for selling draw lottery tickets is also now described.

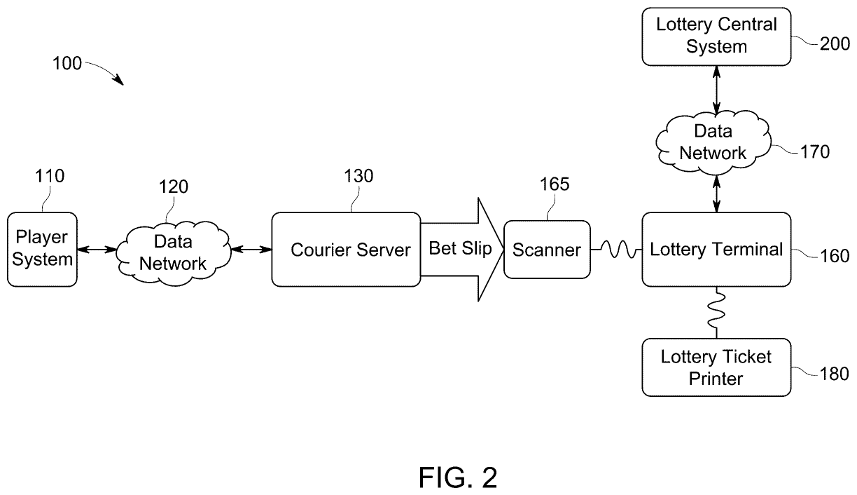

In various jurisdictions (such as states) that do not permit the remote electronic purchase of draw lottery tickets (such as via a website), a draw lottery ticket selling system 100 using a courier service has been employed. Turning to FIG. 2, the draw lottery ticket system 100 includes: (a) an electronic player system 110 with a courier mobile application downloaded thereon; (b) a courier server 130; (c) a lottery terminal 160; (d) a scanner 165 that is part of or that is associated with the lottery terminal 160; (e) a draw lottery ticket printer 180; and (f) a central lottery system 200. The electronic player system 110 and the courier server 130 are configured to communicate via a suitable data network 120. The lottery terminal 160 and the scanner 165 are configured to communicate via hard wire such as an USB connector. The lottery terminal 160 and the draw lottery ticket printer 180 are configured to communicate via hard wire such as an USB connector. The lottery terminal 160 and the lottery central system 200 are configured to communicate via a data network 170.

The electronic player system 110 includes a player electronic device such as a smartphone with the courier mobile application downloaded thereon. The courier server 130 includes a server configured to receive draw lottery game bet details from the electronic player system 110 via the courier mobile application and to generate a suitable bet for a play of the draw lottery game based on the draw lottery game bet details. The bet includes the player numbers for a selected play of a selected draw lottery game. The courier server 130 causes a bet slip based on the bet to be printed such that the bet slip can be scanned by the scanner 165. A human courier processing clerk takes the physical printed paper bet slip for the play of the draw lottery game to the lottery terminal 160 to scan the physical printed paper bet slip. The scanner 165 scans the bet slip and the lottery terminal 160 uses that bet slip scan data to determine the player numbers for the play of the draw lottery game and to create the draw lottery ticket for the player. The lottery terminal 160 causes the draw lottery ticket printer 180 to print out the draw lottery ticket with the player numbers. The operator of the lottery terminal 160 also collects the payment for the draw lottery ticket from the courier processing clerk and provides the printed draw lottery ticket to the courier processing clerk. The courier processing clerk takes the physical printed bet slip and the physical printed draw lottery ticket back to the courier processing center. The courier processing clerk scans the physical printed draw lottery ticket using a courier scanning system (not shown) connected to the courier server 130. The courier server 130 links the scanned draw lottery ticket back to a player account established through the courier mobile application. The courier server 130 then makes the scanned draw lottery ticket available for the player to view via the courier mobile application on the electronic player system 110. The courier processing clerk places the physical printed bet slip and the physical printed draw lottery ticket in secure courier storage locations for storage if needed at a later time.

After the draw for the play of the draw lottery game takes place, if the player's draw lottery ticket is a winning draw lottery ticket and the winning amount is less than $600, the courier server automatically credits the winning amount for the player's draw lottery ticket to the player's account. The courier service can then retrieve and redeem the stored actual winning physical printed draw lottery ticket at a location having a lottery terminal. After the draw for the draw lottery game takes place, if the player's draw lottery ticket is a winning draw lottery ticket and the winning amount is $600 or more, a courier processing clerk retrieves the stored winning physical player draw lottery ticket from the courier storage location and provides that physical printed draw lottery ticket to the player so that the player can redeem that draw lottery ticket and obtain the winning amount.

The present disclosure is configured to be employed with various improvements to the courier service system described above.

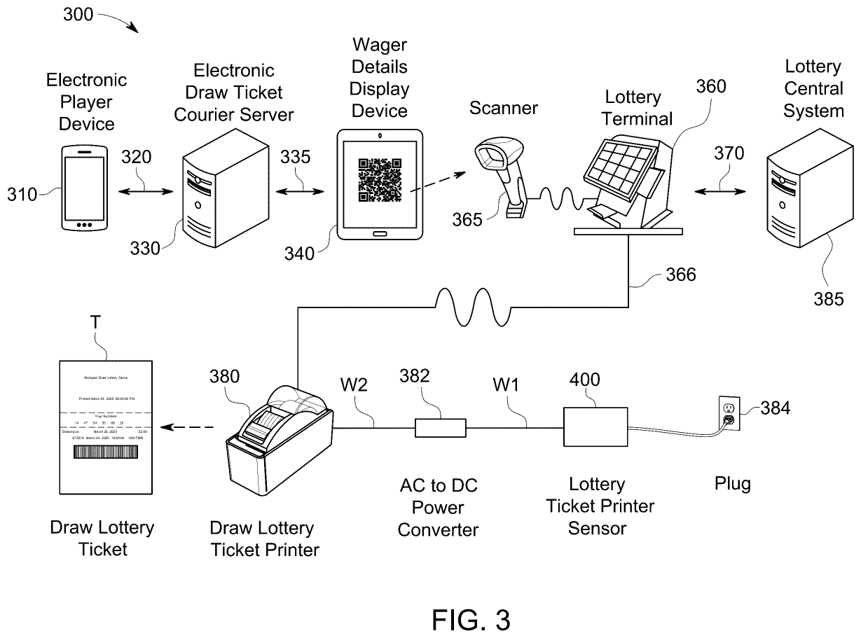

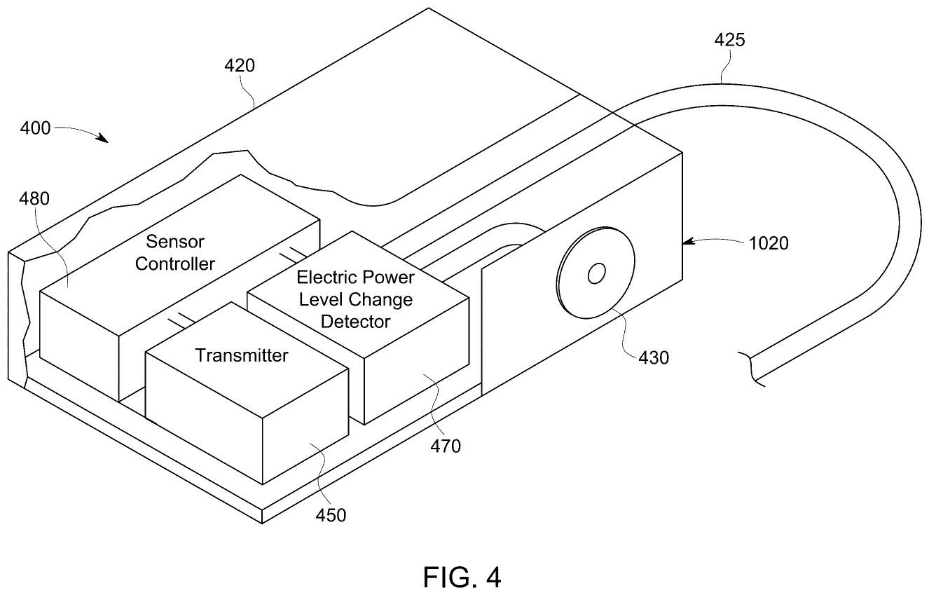

Turning now to FIGS. 3 and 4, an example lottery ticket selling system 300 in accordance with one example embodiment of the present disclosure is generally shown.

This illustrated example lottery ticket selling system 300 includes: (a) an electronic player device 310 with a courier mobile application downloaded thereon; (b) an electronic draw ticket courier server 330; (c) a wager details display device 340; (d) a lottery terminal 360 with an associated scanner 365; (e) a draw lottery ticket printer 380; (f) a lottery central system 385; and (g) a lottery ticket printer sensor 400.

In this illustrated example embodiment, the electronic player device 310 and the courier server 330 are configured to communicate with each other via a suitable data network 320.

In this illustrated example embodiment, the courier server 330 and the wager details display device 340 are configured to communicate with each other via a hard wire connection. In other embodiments, the communication between these components can be via wireless connection such as Bluetooth, or other suitable data connection such as via a suitable data network (such as but not limited to a cellular data network or the Internet).

In this illustrated example embodiment, the lottery terminal 360 and the draw lottery ticket printer 380 are configured to communicate with each other via hard wire 366 such as an USB connector. In other embodiments, the communication between these components can communicate be via a suitable data network. In other embodiments, the draw lottery ticket printer 380 can be built into the same housing as the lottery terminal 360 and thus be physically connected by hard wires therein.

In this illustrated example embodiment, the lottery terminal 360 and the lottery central system 385 are configured to communicate with each other via a suitable data network 370 such as a secure data network.

Generally, the lottery ticket selling system 300: (1) enables a purchaser to employ the electronic player device 310 to order and purchase a draw lottery ticket for a play of a draw lottery game; (2) causes the electronic player device 310 to send an order including the wager details for the purchase of the draw lottery ticket to the courier server 330; (3) causes the courier server 330 to generate a wager details code (such as a QR code) based on the wager details for the ordered draw lottery ticket to be purchased; (4) causes the courier server 330 to cause the wager details display device 340 to display the code to enable scanning of the code by the scanner 365 of the lottery terminal 360 to enable the lottery terminal 360 to obtain the wager details for the ordered draw lottery ticket to be purchased; (5) causes generation of the draw lottery ticket based on the wager details; (6) generates and sends the draw lottery ticket data to the lottery central system 385; and (7) causes the draw lottery ticket printer 380 to print the purchased draw lottery ticket such as ticket T.

The present disclosure addresses the specific issue of ensuring that a physical draw lottery ticket is printed for each displayed wager details code and thus each draw lottery ticket ordered for purchase. The present disclosure enables confirmation that each corresponding draw lottery ticket for each wager details code displayed by the wager details display device 340 is printed by the draw lottery ticket printer 380 before the wager details display device 340 removes the display of the wager details code for that ordered draw lottery ticket and displays a wager details code for a next ordered draw lottery ticket to purchased and to be printed by the system 300. Generally, after the lottery ticket printer sensor 400 detects the printing of the draw lottery ticket (corresponding to a wager details code) by the draw lottery ticket printer 380, the lottery ticket printer sensor 400 sends a signal to the courier server 330 that confirms that the draw lottery ticket was printed. The courier server 330 can then cause the display by the wager details display device 340 of the code for a next ordered draw lottery ticket being purchased via the system 300. In alternative embodiments, after the lottery ticket printer sensor 400 detects the printing of the draw lottery ticket (corresponding to a wager details code) by the draw lottery ticket printer 380, the lottery ticket printer sensor 400 sends a signal to the wager details display device 340 that confirms that the draw lottery ticket was printed. The wager details display device 340 can then remove the display of the code for that printed draw lottery ticket and can then cause the display of the code for the next ordered draw lottery ticket being purchased via the system 300 that it has received from the courier server 330. These configurations enable the system 300 to process multiple draw lottery ticket purchase orders from multiple electronic player devices, que the codes for such ordered draw lottery tickets, and ensure that each draw lottery ticket is printed.

The lottery ticket printer sensor 400 of one example embodiment of the present disclosure is generally diagrammatically illustrated in FIG. 4. For brevity, this illustrated example lottery ticket printer sensor 400 is sometimes referred to herein as a “printer sensor” or as a “sensor.” This illustrated example printer sensor 400 includes: (a) a housing 420; (b) an electric plug receptacle 430 supported by the housing 400; (c) a power cord 425 supported by and extending from the housing 420; (d) a transmitter 450 supported by the housing 420; (e) an electric power level change detector 470 supported by the housing 420; (f) an onboard sensor controller 480 supported by the housing 420; and (g) one or more additional suitable electrical or mechanical components (not shown) such as an on/off switch (not shown) supported by the housing 420. These electrical components are suitably electrically connected by the additional electrical components (not shown). Generally, the electric plug receptacle 430, the power cord 440, the transmitter 450, the electric power level change detector 470, the onboard sensor controller 480, and other electrical and mechanical components are arranged or configured and electrically and mechanically connected such that when the power cord 425 is connected to an electric power source (such as power source 384) and an electric plug (not shown) of the lottery ticket printer 380 (or an AC to DC convertor such as converter 382) is connected to the receptacle 430, the draw lottery ticket printer 380 will receive its electric power (such as AC power or DC power as required for the draw lottery ticket printer 380) through the sensor 400. The electric power level change detector 470 of the sensor 400 will thus be able to detect changes in the electric power level of the electric current supplied or drawn through the sensor 400 to the lottery ticket printer 380 when a draw lottery ticket is printed by the lottery ticket printer 380. The onboard controller 480 and the transmitter 450 will send out one or more signals regarding any such detected electric power level changes of the draw lottery ticket printer 380. The signals are sent to the courier server 330 to indicate that a draw lottery ticket has been printed by the draw lottery ticket printer 380, and thus for the courier server 330 to be able to move on to processing a next ordered draw lottery ticket.

More specifically, the housing 420 includes a plurality of suitably connected walls (not labeled). It should be appreciated that any suitable housing can be employed in accordance with the present disclosure.

The electric plug receptacle 430 is supported by one or more of the walls of the housing 420. The electric plug receptacle 430 is configured to receive a plug (not shown) at one end of a first electric power communication hard wire W1. The other end of the wire W1 is plugged into an AC to DC converter 382 in this example embodiment and thus wire W1 transmits AC electric power to the AC to DC converter 382. The AC to DC converter 382 converts the AC power to DC power. A second electric power communication hard wire W2 connects the AC to DC converter 382 to the draw lottery ticket printer 380 to supply DC power to the draw lottery ticket printer 380. Thus, the electric power supplied to the draw lottery ticket printer 380 is supplied through the sensor 400.

The transmitter 450 is positioned in and connected to the housing 420. The transmitter 450, in various embodiments, includes suitable components (not shown) for wirelessly transmitting signals to the courier server 330. Alternatively, the transmitter 450 is connected via a suitable hard wire (not shown) to the courier server 330. The transmitter 450 can be or include any suitable type of transmitting device. In certain embodiments of the present disclosure, the transmitter 450 is configured to only send out signals to the courier server 330. In other embodiments, the transmitter 450 is configured to send out and receive signals to the courier server 330.

The onboard sensor controller 480 is positioned in and suitably connected to the housing 420. It should be appreciated that the onboard sensor controller 480 can be any suitable type of automatic electrical or electronic computing device or circuit board. For example, in one example embodiment, the onboard controller includes a processor (such as a microprocessor) and a memory device. In another example embodiment, the onboard sensor controller includes an electric circuit hard wired to perform the necessary functions or determinations described herein. For this example embodiment, the onboard sensor controller 480 is configured to: (a) determine variations in the electric power level changes of the electric current provided to or drawn by the draw lottery ticket printer 380; (b) determine if these variations indicate printing of a draw lottery ticket by the draw lottery ticket printer 380; and (c) cause the transmitter 450 to send out one or more signals indicating same to the courier server 330.

The electric power level change detector 470 is positioned in and connected to the housing 420. The electric power level change detector 470 can be any suitable type of electric power level change detecting device that provides the functions described herein.

The draw lottery ticket printer 380 can operate at multiple different electric power levels such as: (1) at higher than resting electric power level at start-up; (2) at a resting electric power level when on but not printing any draw lottery ticket; and (3) at a higher electric power level when printing a draw lottery ticket. These electric power levels can be single amounts or ranges.

It should be appreciated that the present disclosure contemplates that in various embodiments, the electric power level change detector 470 detects changes in amperage of the electric current supplied to the draw lottery ticket printer 380 through the sensor 400. Amperage, amperes, or amps are terms often used to refer to a measure of electrical current. In simple terms, amperage, amperes, or amps is considered a measure of the quantity of electrons moving in a circuit. In other words, amperage (i.e., in the International System of Units or SI unit for electrical current) is the amount of electrical charge that flows through a conductor in a given time period. For example, one ampere is a charge of one coulomb —about 6.241×1018 electrons—per second flowing in a conductor (such as a wire) past a given point.

It should be appreciated that in other embodiments of the present disclosure, the electric power level change detector 470 is configured to sense one or more other characteristics of the electric current supplied to the draw lottery ticket printer 380 through the sensor 400. For example, in other example embodiments, the electric power level change detector detects changes in voltage. Voltage is a measure of the pressure on the electrons to move out of the source. It is directly proportional to the pressure exerted on the electrons. In other words, the higher the voltage, the higher the pressure. For example, a battery of 3 volt will exert pressure on the electrons twice as hard as a battery of 1.5 volt. However, since voltage is more of a measurement of “potential” energy available, not necessarily how much is actually used by the printer, this characteristic may not be an optimal characteristic for the present disclosure. In other example embodiments, the electric power level change detector detects changes in wattage of the electric current supplied to the draw lottery ticket printer 380 through the sensor 400. The wattage or watts used by an electrical device is amps multiplied by volts. A current of one amp at one volt uses one watt of power. An electrical device rated at 10 amps plugged in to a 110-volt supply will use 1,110 watts.

It should be appreciated that the present disclosure contemplates various different operational configurations for the electric power level detector 470, the onboard sensor controller 480, and the sensor 400. The operational configurations are generally “smart” or “dumb” configurations.

In various “smart” configuration embodiments, the electric power level detector 470 detects the amount of power drawn by the printer 380 on a continuous or regular basis and the onboard controller 480 determines any designated variations of the electric power level usage from the resting electric power level of the printer 380. The onboard sensor controller 480 determines if there are any variations from the resting operation of the printer 380 and alone (or in combination with other data) determines whether the printer 380 is printing a draw lottery ticket. In various “smart” configuration embodiments, the onboard sensor controller 480 “knows” or has the appropriate data that represents the electric power level that the printer 380 will normally start at, rest at, and print at. It should be appreciated that the onboard sensor controller 480 can have or obtain this electric power level data in a variety of different suitable manners in accordance with the present disclosure. For example, in a first manner, the controller 480 is initiated with these electric power levels. In a second manner, the controller 480 is initiated with a plurality of predetermined electric power levels. In this embodiment, the printer power sensor first operates in an initiation mode, where the controller 480 determines which of the different predetermined electric power levels is appropriate for the printer connected to that printer power sensor. In a third manner, the controller 480 does not have any preset electric power levels. The sensor first operates in an initiation mode, where the controller 480 determines the electric power levels of the printer connected to that sensor. In a fourth manner, the controller 480 does not have any preset electric power levels. The transmitter of the sensor is configured to receive signals from the courier server that indicate the electric power levels of the printer connected to that sensor. In a fifth manner, the controller 480 does not have any preset electric power levels. The sensor includes an input device such as a switch or dial (not shown) which is suitably connected to the controller 480. The input device enables the user to input the electric power levels of the printer connected to that sensor. It should be appreciated that other suitable manners of providing the controller 480 with the appropriate electric power levels can be employed in accordance with the present disclosure.

In various “dumb” configuration embodiments, the electric power level detector detects the electric power level drawn by the printer on a continuous or regular basis and the transmitter sends signals to the courier server 330 that receives these signals and then determines if there are any variations in the electric power level usage detected. In these “dumb” embodiments, the sensor acts as a dumb device because it does not itself determine if there are variations from the resting operation of the printer and thus does not by itself determine the printing of the draw lottery tickets. In these embodiments, the printer power sensor can be used with any printer regardless of the electric power level(s) of the printer because the sensor does not need to know these electric power level(s) to function. In certain of these embodiments, the sensor does not need to have an onboard controller. In various “dumb” configuration embodiments, the processor of the courier server 330 that receives the signals from the transmitter determines based on these signals or the data provided by these signals if there are any variations from the resting level printer and thus whether the printer printing a draw lottery ticket. It should be appreciated that the courier server 330 can have or obtain this resting electric power level data for the specific printer that the sensor is connected to in any of variety of different manners in accordance with the present disclosure.

It should be appreciated that in the alternative embodiment mentioned above where the sensor send the signals to the wager details display device instead of the courier server, that the above described functions of sending, receiving, and processing the signals related to the additional electric power supplied and drawn by the printer would vary with respect to where these signals are sent and where these signals are received and acted upon. It should be appreciated that in the alternative embodiment mentioned above where the sensor sends the signals to the wager details display device instead of the courier server, that the wager details display device will include a suitable processor and memory device or another controller.

In various alternative embodiments, the draw lottery ticket printer is powered by AC power and the AC to DC converter 382 is not employed.

In various alternative embodiments, the draw lottery ticket printer is powered by DC power and an additional DC electric power sensor (not shown) is additionally employed to monitor changes in the DC power levels supplied to and drawn by the printer (in the same or a similar manner as the sensor 400) and in addition to the monitoring provided by the sensor 400. In such embodiments, the additional sensor can also send signals to the courier server.

In various alternative embodiments, the draw lottery ticket printer is powered by DC power and a DC electric power sensor (not shown) is employed to monitor changes in the DC power levels supplied to the printer (in the same or a similar manner as the sensor 400 described above), and a sensor that monitors the AC power is not employed. In such embodiments, the additional sensor can also send signals to the courier server.

In various alternative embodiments, the controller 480 is not part of the sensor 400 and is separate from the sensor 400.

It should be appreciated from the above that the present disclosure provides devices for confirming the printing of the draw lottery tickets by the draw lottery ticket printer 380 without changing the draw lottery ticket printer 380 or operation thereof.

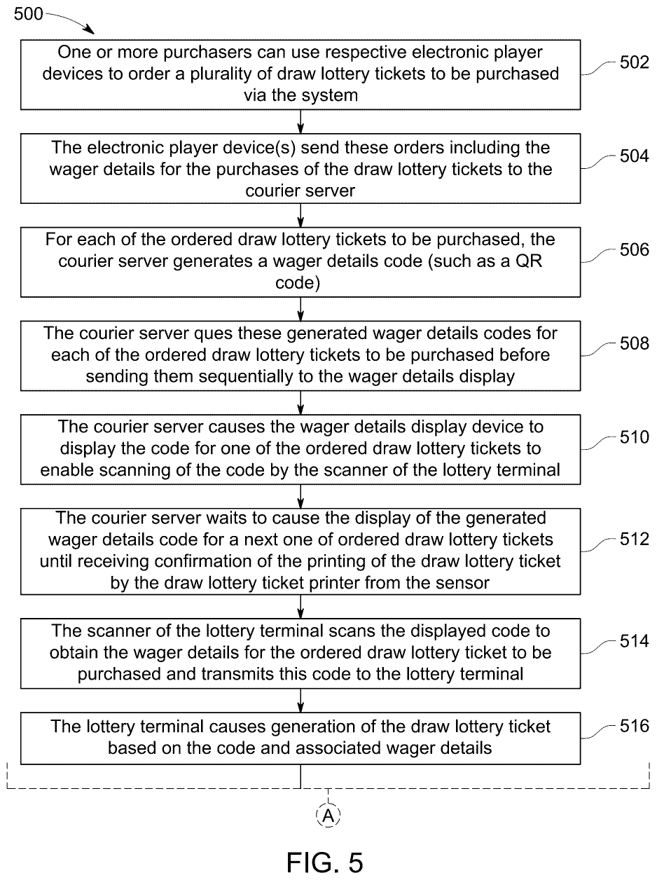

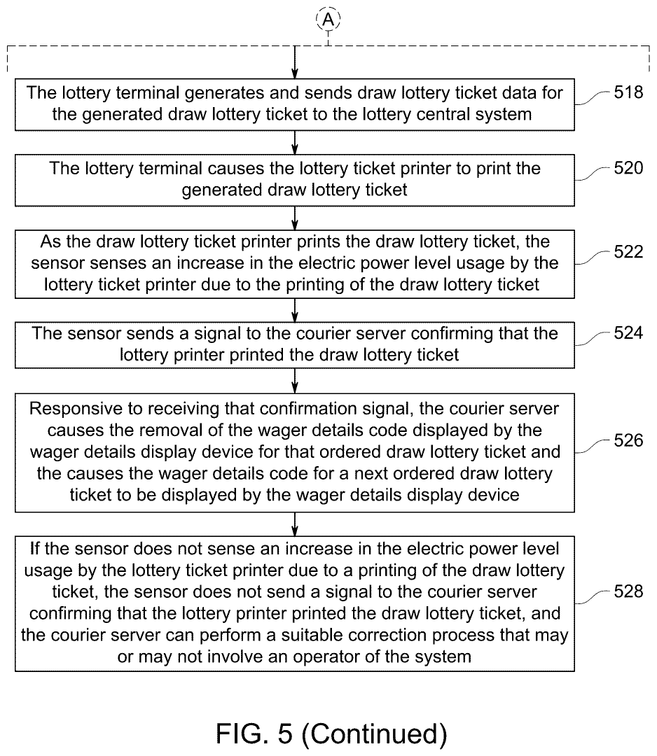

Various embodiments of present disclosure provide various methods of operating the systems of the present disclosure. FIG. 5 is a flowchart of an example method 500 of operating the system 300 of the present disclosure. In various embodiments, the method is represented by sets of instructions stored in the respective memories and executed by the respective processors. Although the method is described with reference to the flowchart shown in FIG. 5, many other processes of performing the acts associated with this illustrated method can be employed. For example, the order of certain of the illustrated blocks or diamonds can be changed, certain of the illustrated blocks or diamonds can be optional, or certain of the illustrated blocks or diamonds may not be employed.

One or more purchasers can use respective electronic player devices to order a plurality of draw lottery tickets to be purchased via the system, as indicated by block 502.

The electronic player device(s) send these orders including the wager details for the purchases of the draw lottery tickets to the courier server, as indicated by block 504.

For each of the ordered draw lottery tickets to be purchased, the courier server generates a wager details code (such as a QR code), as indicated by block 506.

The courier server ques these generated wager details codes for each of the ordered draw lottery tickets to be purchased before sending them sequentially to the wager details display, as indicated by block 508.

The courier server causes the wager details display device to display the code for one of the ordered draw lottery tickets to enable scanning of the code by the scanner of the lottery terminal, as indicated by block 510.

The courier server waits to cause the display of the generated wager details code for a next one of ordered draw lottery tickets until receiving confirmation of the printing of the draw lottery ticket by the draw lottery ticket printer from the sensor, as indicated by block 512.

The scanner of the lottery terminal scans the displayed code to obtain the wager details for the ordered draw lottery ticket to be purchased and transmits this code to the lottery terminal, as indicated by block 514.

The lottery terminal causes generation of the draw lottery ticket based on the code and associated wager details, as indicated by block 516.

The lottery terminal generates and sends draw lottery ticket data for the generated draw lottery ticket to the lottery central system, as indicated by block 518.

The lottery terminal causes the lottery ticket printer to print the generated draw lottery ticket, as indicated by block 520.

As the draw lottery ticket printer prints the draw lottery ticket, the sensor senses an increase in the electric power level usage by the lottery ticket printer due to the printing of the draw lottery ticket, as indicated by block 522.

The sensor sends a signal to the courier server confirming that the lottery printer printed the draw lottery ticket, as indicated by block 524.

Responsive to receiving that confirmation signal, the courier server causes the removal of the wager details code displayed by the wager details display device for that ordered draw lottery ticket and the causes the wager details code for a next ordered draw lottery ticket to be displayed by the wager details display device, as indicated by block 526.

The process indicated by blocks 510 to 526 sequentially repeats for each ordered draw lottery ticket and each printed draw lottery ticket.

If the sensor does not sense an increase in the electric power level usage by the lottery ticket printer due to a printing of the draw lottery ticket, the sensor does not send a signal to the courier server confirming that the lottery printer printed the draw lottery ticket, and the courier server can perform a suitable correction process that may or may not involve an operator of the system, as indicated by block 528. If the correction process involves an operator of the system, the courier server can cause an indication of the need for the correction process to the operator in any suitable manner such as via one or more display light or other indicators.

It should be appreciated that in further embodiments, the power sensor can be configured to monitor the power used or drawn by each of multiple draw lottery ticket printer.

It should be appreciated that in further embodiments, the power sensor can include multiple indicators that indicate the status of the power sensor and changes in power used or drawn by each draw lottery ticket printer.

It should be appreciated from the above that various embodiments of the present disclosure provide a lottery ticket selling system comprising: (1) a wager details display device; (2) a ticket courier server that, responsive to receiving an order for a draw lottery ticket from an electronic player device with a courier mobile application, causes a display of a code associated with the ordered draw lottery ticket by the wager details display device; (3) a lottery terminal and associated scanner, the lottery terminal configured to communicate with a lottery central system; (4) a draw lottery ticket printer; and (5) a lottery ticket printer sensor comprising an electric power level change detector, a transmitter, a processor, and a memory device that stores a plurality of instructions, which when executed by the processor cause the processor to: (a) receive a first signal from the electric power level change detector that indicates that the draw lottery printer printed a draw lottery ticket corresponding to the code, and (b) send a second signal, via the transmitter, which indicates that the draw lottery ticket printer printed the draw lottery ticket and that causes the ticket courier server to cause a removal of the display of the code associated with that draw lottery ticket by the wager details display device. In various such embodiments, the electric power level change detector is an AC electric power level change detector. In various such embodiments, the electric power level change detector is an AC electric power level change detector, and the draw lottery ticket printer is a DC electric powered draw lottery ticket printer. In various such embodiments, the electric power level change detector is a DC electric power level change detector, and the draw lottery ticket printer is a DC electric powered draw lottery ticket printer. In various such embodiments, the electric power level change detector is an amperage level change detector. In various such embodiments, the code associated with the ordered draw lottery ticket is associated with wager details comprising player numbers, draw game and date, and player identification. In various such embodiments, the second signal causes the ticket courier server to cause the wager details display device display to display another code associated with another ordered draw lottery ticket after the ticket courier server causes the removal of the display of the code associated with the draw lottery ticket by the wager details display device. In various such embodiments, the second signal causes the ticket courier server to cause the wager details display device display to display another code associated with another ordered draw lottery ticket as part of the removal of the display of the code associated with the draw lottery ticket by the wager details display device.

It should further be appreciated from the above that various embodiments of the present disclosure provide a lottery ticket selling system comprising: (1) a wager details display device; (2) a ticket courier server that, responsive to receiving an order for a draw lottery ticket, causes a display of a code associated with an ordered draw lottery ticket by the wager details display device; (3) a lottery terminal and associated scanner; (4) a draw lottery ticket printer; and (5) a lottery ticket printer sensor comprising an electric power level change detector, a transmitter, a processor, and a memory device that stores a plurality of instructions, which when executed by the processor cause the processor to: (a) receive a first signal from the electric power level change detector that indicates that the draw lottery printer printed a draw lottery ticket, and (5) send a second signal, via the transmitter, which indicates that the draw lottery ticket printer printed the draw lottery ticket and that causes a removal of the display of the code associated with that draw lottery ticket from the wager details display device. In various such embodiments, after and responsive to the second signal being received by the ticket courier server, the ticket courier server causes the removal of the display of the code associated with that draw lottery ticket from the wager details display device. In various such embodiments, after and responsive to the second signal being received by the ticket courier server, the ticket courier server causes the removal of the display of the code associated with that draw lottery ticket from the wager details display device, and a display of another code associated with another draw lottery ticket by the wager details display device. In various such embodiments, after and responsive to the second signal being received by the wager details display device, the wager details display device causes the removal of the display of the code associated with that draw lottery ticket from the wager details display device. In various such embodiments, after and responsive to the second signal being received by the wager details display device, the wager details display device causes the removal of the display of the code associated with that draw lottery ticket from the wager details display device, and a display of another code associated with another draw lottery ticket by the wager details display device. In various such embodiments, after and responsive to the second signal being received by the wager details display device, the wager details display device causes the removal of the display of the code associated with that draw lottery ticket from the wager details display device, and a display of another code associated with another draw lottery ticket by the wager details display device received from the ticket courier server.

It should further be appreciated from the above that various embodiments of the present disclosure provide a lottery ticket selling system comprising: (1) a wager details display device; (2) a ticket courier server that, responsive to receiving a first order for a first draw lottery ticket, causes a display of a first code associated with an ordered first draw lottery ticket by the wager details display device; (3) a lottery terminal and associated scanner, the lottery terminal configured to communicate with a lottery central system; (4) a draw lottery ticket printer; and (5) a lottery ticket printer sensor comprising an electric power level change detector, a transmitter, a processor, and a memory device that stores a plurality of instructions, which when executed by the processor cause the processor to: (a) receive a first signal from the electric power level change detector that indicates that the draw lottery printer printed a first draw lottery ticket associated with the first code, and (v) send a second signal, via the transmitter, which indicates that the draw lottery ticket printer printed the first draw lottery ticket and that causes a removal of the display of the first code associated with that first draw lottery ticket by the wager details display device. In various such embodiments, the ticket courier server, responsive to receiving a second order for a second draw lottery ticket, does not cause a display of a second code associated with the ordered second draw lottery ticket by the wager details display device until receiving the second signal via the transmitter. In various such embodiments, the ticket courier server, responsive to receiving a second order for a second draw lottery ticket, does not cause a display of a second code associated with the ordered second draw lottery ticket by the wager details display device until after the removal of the display of the first code associated with that first draw lottery ticket by the wager details display device. In various such embodiments, the plurality of instructions, when executed by the processor, cause the processor to: receive a third signal from the electric power level change detector that indicates that the second draw lottery printer printed the second draw lottery ticket associated with the second code, and send a fourth signal, via the transmitter, which indicates that the draw lottery ticket printer printed the second draw lottery ticket and that causes a removal a display of the second code associated with the second draw lottery ticket by the wager details display device. In various such embodiments, the electric power level change detector is an amperage level change detector. In various such embodiments, he first code associated with the ordered first draw lottery ticket is associated with wager details comprising player numbers, draw game and date, and player identification.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A lottery ticket selling system comprising:
a wager details display device;
a ticket courier server that, responsive to receiving an order for a draw lottery ticket from an electronic player device with a courier mobile application, causes a display of a code associated with the ordered draw lottery ticket by the wager details display device;
a lottery terminal and associated scanner, the lottery terminal configured to communicate with a lottery central system;
a draw lottery ticket printer; and
a lottery ticket printer sensor comprising an electric power level change detector, a transmitter, a processor, and a memory device that stores a plurality of instructions, which when executed by the processor cause the processor to:
receive a first signal from the electric power level change detector that indicates that the draw lottery printer printed a draw lottery ticket corresponding to the code, and
send a second signal, via the transmitter, which indicates that the draw lottery ticket printer printed the draw lottery ticket and that causes the ticket courier server to cause a removal of the display of the code associated with that draw lottery ticket by the wager details display device.

2. The lottery ticket selling system of claim 1, wherein the electric power level change detector is an AC electric power level change detector.

3. The lottery ticket selling system of claim 1, wherein the electric power level change detector is an AC electric power level change detector, and the draw lottery ticket printer is a DC electric powered draw lottery ticket printer.

4. The lottery ticket selling system of claim 1, wherein the electric power level change detector is a DC electric power level change detector, and the draw lottery ticket printer is a DC electric powered draw lottery ticket printer.

5. The lottery ticket selling system of claim 1, wherein the electric power level change detector is an amperage level change detector.

6. The lottery ticket selling system of claim 1, wherein the code associated with the ordered draw lottery ticket is associated with wager details comprising player numbers, draw game and date, and player identification.

7. The lottery ticket selling system of claim 1, wherein the second signal causes the ticket courier server to cause the wager details display device display to display another code associated with another ordered draw lottery ticket after the ticket courier server causes the removal of the display of the code associated with the draw lottery ticket by the wager details display device.

8. The lottery ticket selling system of claim 1, wherein the second signal causes the ticket courier server to cause the wager details display device display to display another code associated with another ordered draw lottery ticket as part of the removal of the display of the code associated with the draw lottery ticket by the wager details display device.

9. A lottery ticket selling system comprising:
a wager details display device;
a ticket courier server that, responsive to receiving an order for a draw lottery ticket, causes a display of a code associated with an ordered draw lottery ticket by the wager details display device;
a lottery terminal and associated scanner;
a draw lottery ticket printer; and
a lottery ticket printer sensor comprising an electric power level change detector, a transmitter, a processor, and a memory device that stores a plurality of instructions, which when executed by the processor cause the processor to:
receive a first signal from the electric power level change detector that indicates that the draw lottery printer printed a draw lottery ticket, and
send a second signal, via the transmitter, which indicates that the draw lottery ticket printer printed the draw lottery ticket and that causes a removal of the display of the code associated with that draw lottery ticket from the wager details display device.

10. The lottery ticket selling system of claim 9, wherein after and responsive to the second signal being received by the ticket courier server, the ticket courier server causes the removal of the display of the code associated with that draw lottery ticket from the wager details display device.

11. The lottery ticket selling system of claim 9, wherein after and responsive to the second signal being received by the ticket courier server, the ticket courier server causes the removal of the display of the code associated with that draw lottery ticket from the wager details display device, and a display of another code associated with another draw lottery ticket by the wager details display device.

12. The lottery ticket selling system of claim 9, wherein after and responsive to the second signal being received by the wager details display device, the wager details display device causes the removal of the display of the code associated with that draw lottery ticket from the wager details display device.

13. The lottery ticket selling system of claim 9, wherein after and responsive to the second signal being received by the wager details display device, the wager details display device causes the removal of the display of the code associated with that draw lottery ticket from the wager details display device, and a display of another code associated with another draw lottery ticket by the wager details display device.

14. The lottery ticket selling system of claim 9, wherein after and responsive to the second signal being received by the wager details display device, the wager details display device causes the removal of the display of the code associated with that draw lottery ticket from the wager details display device, and a display of another code associated with another draw lottery ticket by the wager details display device received from the ticket courier server.

15. A lottery ticket selling system comprising:
a wager details display device;
a ticket courier server that, responsive to receiving a first order for a first draw lottery ticket, causes a display of a first code associated with an ordered first draw lottery ticket by the wager details display device;
a lottery terminal and associated scanner, the lottery terminal configured to communicate with a lottery central system;
a draw lottery ticket printer; and
a lottery ticket printer sensor comprising an electric power level change detector, a transmitter, a processor, and a memory device that stores a plurality of instructions, which when executed by the processor cause the processor to:
receive a first signal from the electric power level change detector that indicates that the draw lottery printer printed a first draw lottery ticket associated with the first code, and
send a second signal, via the transmitter, which indicates that the draw lottery ticket printer printed the first draw lottery ticket and that causes a removal of the display of the first code associated with that first draw lottery ticket by the wager details display device.

16. The lottery ticket selling system of claim 15, wherein the ticket courier server, responsive to receiving a second order for a second draw lottery ticket, does not cause a display of a second code associated with the ordered second draw lottery ticket by the wager details display device until receiving the second signal via the transmitter.

17. The lottery ticket selling system of claim 15, wherein the ticket courier server, responsive to receiving a second order for a second draw lottery ticket, does not cause a display of a second code associated with the ordered second draw lottery ticket by the wager details display device until after the removal of the display of the first code associated with that first draw lottery ticket by the wager details display device.

18. The lottery ticket selling system of claim 17, wherein the plurality of instructions, when executed by the processor, cause the processor to:
receive a third signal from the electric power level change detector that indicates that the second draw lottery printer printed the second draw lottery ticket associated with the second code, and
send a fourth signal, via the transmitter, which indicates that the draw lottery ticket printer printed the second draw lottery ticket and that causes a removal a display of the second code associated with the second draw lottery ticket by the wager details display device.

19. The lottery ticket selling system of claim 15, wherein the electric power level change detector is an amperage level change detector.

20. The lottery ticket selling system of claim 15, wherein the first code associated with the ordered first draw lottery ticket is associated with wager details comprising player numbers, draw game and date, and player identification.
